(19) United States
(12) Patent Application Publication
(10) Pub. No.: US 2004/0230019 A1
(43) Pub. Date: Nov. 18, 2004

(54) Poly (alpha-methylene-gama-methyl-gamma-butyrolactone-c-glycidyl methacrylate): preparation, polymer blends derived therefrom, and end uses thereof

(76) Inventor: Charles J. Brandenburg, Newark, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/766,412

(22) Filed: Jan. 28, 2004

Related U.S. Application Data
(60) Provisional application No. 60/444,329, filed on Jan. 31, 2003.

(51) Int. Cl. C08F 24/00

(52) U.S. Cl. 526/266; 526/319

(57) ABSTRACT

An aspect of this invention discloses novel copolymeric compositions with repeat units of glycidyl methacrylate and alpha-methylene-gamma-methyl-gamma-butyrolactone. This invention also discloses an emulsion polymerization process for making such copolymers. This invention further discloses blends of such copolymers with polyamides and blends of such copolymers with polyesters. This invention further discloses a process for improving mechanical properties of polyamides and polyesters.

This application claims the benefit of U.S. Provisional Application 60/444,329, filed Jan. 31, 2003.

### FIELD OF INVENTION

Disclosed herein are novel copolymeric compositions with repeat units of glycidyl methacrylate and alpha-methylene-gamma-methyl-gamma-butyrolactone. Also disclosed are blends of such copolymers with polyamides and blends of such copolymers with polyesters. Also disclosed is a process for making the compositions and the blends.

### BACKGROUND

One embodiment of this invention relates to copolymers derived from alpha-methylene lactone (alpha-ML) and glycidyl methacrylate (GMA) and the emulsion polymerization process to prepare these compositions. Another aspect of this invention relates to a polymer mixture comprising a polyamide or polyester and at least one such copolymer of alpha-ML/GMA, wherein the GMA repeat units act as a reactive compatibilizer between the polyamide or polyester and the alpha-ML copolymer. Another aspect of this invention is a method of preparing alpha-ML/GMA copolymers via emulsion polymerization wherein the particle size of the coagulated copolymer can be controlled.

U.S. Pat. No. 5,430,126 discloses a process for preparing brominated styrene polymer particles wherein a dual organic solvent system is added to the latex after coagulation to obtain polymeric particles of desired size. The organic solvents suitable for such purpose are, for example, toluene and heptane. Similarly, U.S. Pat. No. 4,977,241 discloses a dual organic solvent system for controlling the particle size of methyl methacrylate-co-butyl acrylate copolymers prepared by emulsion. Hexane and toluene were added after coagulation of the latex to give the desired particle size.

Polymer blending is a very attractive method for obtaining new materials with synergistic physical properties. However, most polymer blends are incompatible and require a compatibilizer to obtain desirable physical properties. For example, the compatibilizer either interacts chemically with both phases or has a specific interaction with one phase and physical interaction with the other (Tedesco, et al., Polymer Testing, 21, 11-15 (2002)). For example, addition of an appropriate graft or a block copolymer reduces the interfacial tension between the two incompatible phases and increases the surface area of the dispersed phase such that adhesion is promoted in the binary system and the morphology of the dispersed phase is stabilized.

Glycidyl methacrylate has been used as a monomer for grafting onto polyolefins to make them compatible with polyamides. The presence of the epoxy group promotes reaction with either an acidic (—COOH) or the basic (—NH2) group of the polyamide. (Id. at 11).

U.S. Pat. No. 5,869,572 teaches blending of polyamide and polyphenylene ether in the presence of an olefinic-based copolymer such as ethylene-propylene copolymer to improve the impact resistance. In U.S. Pat. No. 6,316,551 B1, compatible blends of polyamide and polyphenylene ether are prepared without a compatibilizing agent to improve the impact resistance of the final composition. The present invention relates to a composition and method of making polymeric blends of polyamides or polyesters and alpha-ML/GMA copolymers to give desirable physical properties.

Blends derived from alpha-ML/GMA copolymers and thermoplastic polymers have outstanding physical properties. Shaped, extruded and molded articles made from such blends have applications in markets such as automotive parts, electrical connectors, consumer and industrial products.

### SUMMARY OF INVENTION

This invention relates to a copolymer composition comprising

(a) at least one polymeric repeat unit represented by formula I derived from alpha-methylene lactone monomer,

(b) at least one polymeric repeat unit represented by formula II derived from glycidyl methacrylate monomer, and

(c) optionally, at least one polymeric repeat unit represented by formula III derived from a monoethyleneically unsaturated monomer,

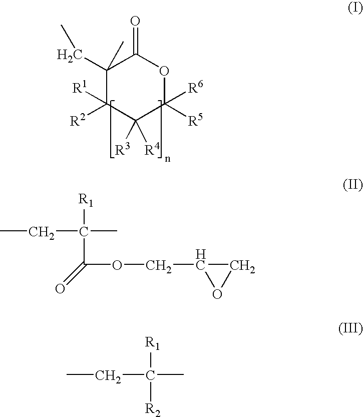

wherein: n is 0, 1 or 2;

R¹, R², R³, R⁴, R⁵, R⁶, are independently hydrogen, a functional group, hydrocarbyl or substituted hydrocarbyl.

This invention also relates to a composition comprising:

(a) at least one polymeric repeat unit represented by formula I derived from alpha-methylene lactone monomer,

(b) at least one polymeric repeat unit represented by formula II derived from glycidyl methacrylate monomer, wherein said polymeric repeat unit represented by formula II comprises from about 0.5% to about 45% by weight of the copolymer composition;

(c) at least one thermoplastic material selected from polyamide or polyester,

(d) optionally, from 1% to 50% of at least one a polymeric repeat unit represented by formula III derived from a monoethyleneically unsaturated monomer, and

(e) optionally, one or more impact modifier in the range from 0.5% to 35% by total weight of the composition,

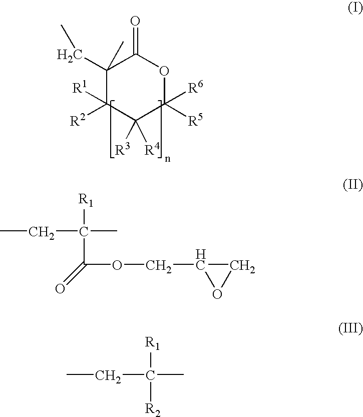

wherein: n is 0, 1 or 2;

R¹, R², R³, R⁴, R⁵, R⁶, are independently hydrogen, a functional group, hydrocarbyl or substituted hydrocarbyl.

This invention further relates to a method of preparing a copolymer composition, the method comprising the steps of:

(a) contacting at least one alpha methylene lactone monomer of formula (I) with a glycidyl methacrylate monomer of general formula (II), in an aqueous medium,

(b) optionally, contacting the product of step (a) with a chain-transfer agent and a surfactant,

(c) contacting the product of step (a) or step (b) with an initiator,

(d) contacting the product of step (c) with a coagulant, to obtain the copolymer composition,

(e) optionally, contacting the product of step (d) with ethyl acetate,

(f) optionally, agitating the product of step (e),

(g) optionally, filtering the copolymer composition, and

(e) optionally, drying the copolymer composition.

### DRAWINGS

FIG. 1 is a transmission electron micrograph, supporting example 66, of a composition of a copolymer particle having 0 Wt % GMA in the MeMBL copolymer

FIG. 2 is a transmission electron micrograph, supporting example 67, of a composition of a copolymer particle having 1 Wt % GMA in the MeMBL copolymer

FIG. 3 is a transmission electron micrograph, supporting example 68, of a composition of a copolymer particle having 2 Wt % GMA in the MeMBL copolymer

FIG. 4 is a transmission electron micrograph, supporting example 69, of a composition of a copolymer particle having 3 Wt % GMA in the MeMBL copolymer

### DETAILED DESCRIPTION OF THE INVENTION

The terms used in the present invention are defined below.

A “hydrocarbyl group” is a univalent group containing only carbon and hydrogen. If not otherwise stated, it is preferred that hydrocarbyl groups (and alkyl groups) herein contain 1 to about 30 carbon atoms.

By “substituted hydrocarbyl” herein is meant a hydrocarbyl group, which contains one or more substituent groups, which are inert under the process conditions to which the compound containing these groups is subjected. The substituent groups also do not substantially interfere with the process. If not otherwise stated, it is preferred that substituted hydrocarbyl groups herein contain 1 to about 30 carbon atoms. Included in the meaning of “substituted” are heteroaromatic rings. In substituted hydrocarbyl, all of the hydrogens may be substituted, as in trifluoromethyl.

By “functional group” it is meant a group other than hydrocarbyl or substituted hydrocarbyl, which is inert under the process conditions to which the compound or polymer containing the group is subjected. Functional groups do not substantially interfere with any process described herein that the compound or polymer, in which they are present, may take part in. Examples of functional groups include halo (fluoro, chloro, bromo and iodo), ether such as —OR22 wherein R22 is hydrocarbyl or substituted hydrocarbyl.

By reactive functional group it is meant a functional group that may react with another functional group present in the process or composition. By “may react” is meant that the functional group may react with its counterpart reactive group, but it is not necessary that such reaction happen or that all of the reactive functional groups react with one another. Usually in the formation of the compositions described herein, some fraction of these reactive functional groups will react.

By “copolymerizable under free radical conditions” it is meant that the (potential) monomers, preferably vinyl monomers, involved are known to copolymerize under free radical polymerization conditions. The free radicals may be generated by any of the usual processes, for example thermally from radical initiators such as peroxides or azonitriles, by UV-radiation using appropriate sensitizers, etc., and by ionizing radiation. These polymers may be prepared by various types of polymerization processes, such as continuous, batch, and semibatch, which are well known in the art. Many combinations of free radically copolymerizable monomers are known, see for instance, J. Brandrup, et al., Ed., Polymer Handbook, 4^{th} Ed., John Wiley & Sons, New York, 1999, p. II/181-II/308.

By “batch emulsion polymerization” it is meant that all ingredients, including monomers, surfactants, and chain transfer agents, are added at the beginning of the polymerization. The polymerization begins as soon as initiator is added.

By “semi-continuous emulsion polymerization” it is meant that one or more of the ingredients is added continuously or in incremental amounts. The monomers may be added in pure form or as pre-made emulsions. The advantages over a batch process are better control over heat of reaction, particle number, colloidal stability, coagulum formation, and particle morphology.

By “continuous emulsion polymerization” it is meant that one or more ingredients is fed continuously to a polymerization tank or series of tanks and the polymer product (latex) is continuously removed at the same rate. By “low-temperature emulsion polymerization” is meant that emulsion polymerization reaction is carried out with a redox-type initiator.

This invention relates to copolymers derived from alpha-methylene lactone (alpha-ML) and glycidyl methacrylate (GMA), hereinafter referred to as alpha-ML/GMA. In a preferred process of the invention, the alpha-ML/GMA copolymer is prepared by emulsion polymerization. Other generally known methods of extrusion can be used. This invention involves a process for obtaining controlled polymer particle size of alpha-ML/GMA copolymers. The first step in the process is to prepare the alpha-ML/GMA copolymer via emulsion polymerization. The second step is to coagulate the alpha-MBL/GMA emulsion using a standard coagulating agent such as magnesium sulfate. This affords a slurry of very fine polymer particles. The third step is to add an organic solvent, preferably ethyl acetate, to the particle slurry with vigorous stirring. This causes the polymer slurry to agglomerate into polymer beads with uniform size. These polymer beads are very easy to filter and wash. In addition, they are very easy to work with in an extrusion and blending process. The polymer beads can be easily mixed and fed along with standard pellets of engineering resins such as nylon and polyester. If ethyl acetate is not used, the resulting polymer is a very fine powder, which can create problems of contamination and handling.

More specifically, the alpha-ML/GMA copolymer of the invention is comprised of repeat units derived from the monomer represented by formula (I) below and the monomer represented by formula (II) below:

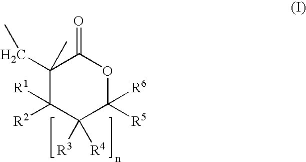

wherein: n is 0, 1 or 2;

R¹, R², R³, R⁴, R⁵, R⁶, are independently hydrogen, a functional group, hydrocarbyl or substituted hydrocarbyl;

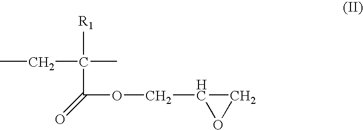

In a further aspect of the invention, the copolymers can be mixed or blended with thermoplastic matrix resins. Various methods of mixing and blending commonly known in the art can be used. These include compounding extruders, Buss Kneaders, Banbury mixers, roll mills, and the like. The powdered or pelletized resins may be dry-blended, then fed to the processing equipment, or alternatively, the resinous components may be simultaneously fed via a split feeder system. Alternatively, the copolymer emulsion may be fed directly to the extruder with devolatilization of the water.

In preferred embodiments of the composition of the invention, the copolymers are blended with polyamide or polyester type thermoplastic materials. The repeat units derived from GMA monomers provide the compatibility for either a homogeneous phase, or a heterogeneous phase with fine dispersion of the said copolymer within the thermoplastic matrix which adequately provides improvement in useful physical properties such as the heat deflection temperature, elongation to break and toughness characteristics of these thermoplastics.

Optionally the copolymers of the invention may comprise a polymeric repeat unit represented by formula III

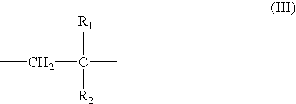

The weight fraction of alpha-ML in the copolymer of the invention can range from about 1% to about 99%. Generally, in a composition comprising alpha-ML/GMA copolymer with a thermoplastic material, the amount of the alpha-ML/GMA copolymer can be present in an amount of about 1% to about 80% by weight of the blend, preferably from about 10% to about 70%, and more preferably from about 20% to about 40%.

The process of the invention provides copolymer particles of controlled size. Controlling the size of the resulting copolymer particles of the invention is accomplished by the addition of ethyl acetate during the coagulation step of the polymerization process. The particle size of the copolymer obtainable by this process can range from about 100 microns to about 5 mm. A preferred particle size is between about 0.5 mm to about 5 mm, and more preferably from about 1 to about 3 mm. The desired size of the particle will depend on the particular desired end-use of the copolymer. For example, a particle size of the copolymer in the range of from about 1 mm to about 2 mm obtained by this process can be useful in mixing with thermoplastic resin pellets which may be a desirable feature for a subsequent intimate blending generally performed by extrusion.

When a coagulant is added to a polymer latex, it is generally believed that the emulsified state is destroyed and that polymer latex particles, which were contained in the polymer latex, agglomerate in large numbers to form primary particles. It has however been difficult to control the sizes of these primary particles. In the process of the invention, the alpha-ML/GMA copolymer emulsion, a coagulant and ethyl acetate are mixed together to coagulate the alpha-ML/GMA copolymer latex. By vigorously agitating the resultant mixture of alpha-ML/GMA latex, such as by stirring, both the sizes of the particles to be formed can be precisely controlled. It is therefore possible to prepare an alpha-ML/GMA particulate copolymer that has a narrow particle size distribution and a volume average particle size of several tens of micrometers to several millimeters directly from the alpha-ML/GMA copolymer latex.

The particulate copolymer generated by the addition of ethyl acetate is substantially free of fine particles. In the absence of ethyl acetate, the alpha-ML/GMA particles coagulate as fine powder usually in the size range of 20 microns or less. These fine powders can create problems of contamination in subsequent processing of the polymer, such as during drying in a fluidized bed dryer during processing, or by being airborne during transportation.

In another embodiment of the invention, the alpha-ML/GMA copolymer of the invention can also contain varying GMA content in the chain. The range of GMA present in the copolymer can be from about 0.5% to about 35%. The GMA content of the copolymer can be easily measured by integration of the GMA signals in the proton NMR spectrum in CDCl₃.

Another embodiment of the invention is a polymeric mixture or a blend of the alpha-ML/GMA copolymer of the present invention with polyamide polymer. It is believed that all thermoplastic polyamides can be used in the copolymeric mixture or blend. Examples of useful polyamides for this invention include the conventional polyamide resins known as nylon resins, including both aliphatic polylactams such as polycaprolactam (nylon 6) and higher analogs such as nylon 11 and nylon 12, and polyamides formed from aliphatic diamines and aliphatic dicarboxylic acids such as polyhexamethylene sebacamide (nylon 6,10) polyhexamethylene adipamide (nylon 6,6), and the like.

Further examples of useful polyamides include the amorphous as well as the crystalline versions, the toughened polyamides, and the aromatic-aliphatic copolymers, terpolymers and tetrapolymers. A great variety of these nylon resins is well known and widely available commercially. Suitable polyamides include, for example, polyamide-4, polyamide-6, polyamide-6,6, polyamide-3,4, polyamide-11, polyamide-12, polyamide-6,10, polyamide-6,12, polyamides prepared from terephthalic acid and 4,4′-diaminocyclohexyl methane, polyamides prepared from azelaic acid, adipic acid and 2,2 bis-(p-aminocyclohexyl)propane, polyamides prepared from adipic acid and metaxylene diamine, polyamides from terephthalic acid and trimethyl hexamethylene diamine, and mixtures thereof.

Useful thermoplastic polyamides can also include poly(hexamethylene adipamide) polyenanthamide (nylon 7); nylon 10; polytetramethyleneadipamide (nylon 4,6); the polyamide of dodecamethylenediamine and n-dodecanedioic acid (nylon 12,12), PACM-12 polyamide derived from bis(4-aminocyclohexyl)methane and dodecanedioic acid, the copolyamide of 30% hexamethylene diammonium isophthalate and 70% hexamethylene diammonium adipate, the copolyamide of up to 30% bis-(P-amidocyclohexyl)methylene, and terephthalic acid and caprolactam, poly(8-aminooctanoic acid) (nylon 8), poly(hapta-methylene pimelamide) (nylon 7,7), poly(octamethylene suberamide) (nylon 8,8), poly(nonamethylene azelamide) (nylon 9,9), poly(decamethylene azelamide) (nylon 10,9), poly(decamethylene sebacamide (nylon 10,10), poly[bis(4-amino-cyclohexyl)methane-1,10-decanedicarboxamide], poly(m-xylene adipamide), poly(p-xylene sebacamide), poly(2,2,2-trimethylhexamethylene pimelamide), poly(piperazine sebacamide), polyhexamethylene isophthalamide, polyhexamethylene terephthalamide, and poly(9-aminononanoic acid) (nylon 9) polycaproamide. Copolyamides can also be used, for example poly(hexamethylene-co-2-methylpentamethylene adipamide) in which the hexamethylene moiety can be present at about 75-90 mol % of total diamine-derived moieties.

Useful thermoplastic polyesters include poly(ethylene terephthalate) (“2GT”) and copolymers thereof, poly(trimethylene terephthalate) (“3GT”), polybutylene terephthalate (“4GT”), and poly(ethylene 2,6-naphthalate), poly(1,4-cyclohexylenedimethylene terephthalate), poly(lactide), poly(ethylene azelate), poly[ethylene-2,7-naphthalate], poly(glycolic acid), poly(lactic acid), poly(ethylene succinate), poly(alpha, alpha-dimethylpropiolactone), poly(para-hydroxybenzoate), poly(ethylene oxybenzoate), poly(ethylene isophthalate), poly(tetramethylene terephthalate, poly(hexamethylene terephthalate), poly(decamethylene terephthalate), poly(1,4-cyclohexane dimethylene terephthalate)(trans), poly(ethylene 1,5-naphthalate), poly(ethylene 2,6-naphthalate), poly(1,4-cyclohexylidene dimethylene terephthalate)(cis), and poly(1,4-cyclohexylidene dimethylene terephthalate)(trans).

Preferred polyesters include poly(ethylene terephthalate), poly(trimethylene terephthalate), and poly(1,4-butylene terephthalate) and copolymers thereof. When a relatively high-melting polyesters such as poly(ethylene terephthalate) is used, a comonomer can be incorporated into the polyester so that it can be processed at reduced temperatures. Such comonomers can include linear, cyclic, and branched aliphatic dicarboxylic acids having 4-12 carbon atoms (for example pentanedioic acid); aromatic dicarboxylic acids other than terephthalic acid and having 8-12 carbon atoms (for example isophthalic acid); linear, cyclic, and branched aliphatic diols having 3-8 carbon atoms (for example 1,3-propane diol, 1,2-propanediol, 1,4-butanediol, and 2,2-dimethyl-1,3-propanediol); and aliphatic and aromatic ether glycols having 4-10 carbon atoms (for example hydroquinone bis(2-hydroxyethyl) ether). The comonomer can be present in the copolyester at a level in the range of about 0.5 to 15 mole percent. Isophthalic acid, pentanedioic acid, hexanedioic acid, 1,3-propane diol, and 1,4-butanediol are preferred comonomers for poly(ethylene terephthalate) because they are readily commercially available and inexpensive.

The polyester can also contain minor amounts of other comonomers, provided such comonomers do not have an adverse affect on final properties. Such other comonomers include 5-sodium-sulfoisophthalate, for example, at a level in the range of about 0.2 to 5 mole percent. Very small amounts, for example, about 0.1 wt % to about 0.5 wt % based on total ingredients, of trifunctional comonomers, for example trimellitic acid, can be incorporated for viscosity control.

Emulsion polymerization temperatures useful for the process of the invention can range from 25° C. to about 100° C., preferably from about 60° C. to about 80° C.

Preferred initiators for the polymerization process include thermal type initiator systems. Examples of thermal initiators include organo peroxides, acetyl peroxides, lauroyl peroxide, t-butyl peroxide, di-t-butyl hydroperoxide, peresters, such as t-butyl peroxypivulates; azo-type initiators, such as azo-bis-isobutyrylnitrile; persulfates, such as sodium, potassium, or ammonium persulfate; and peroxyphosphastes, such as sodium, potassium, or ammonium peroxyphosphate.

Preferred initiators for the polymerization process also include redox-type initiator systems. Redox initiators include, for example, a combination of a hydroperoxide, such as hydrogen peroxide, t-butyl hydroperoxide, cumene hydroperoxide, diisopropyl-benzene hydroperoxide, and the like, and a reducing agent, such as sodium, potassium, or ammonium bisulfite, metabisulfite, or hydrosulfite, sulfur dioxide, hydrazine, ferrous salts, isoascorbic acid, and sodium formaldehyde sulfoxalate.

Suitable surfactants for the polymerization process include, for example, alkali metal, ammonium salts of alkyl, aryl, alkaryl, ara-alkyl sulfonates, sulfates and polyether sulfates, ethoxylated fatty acids, esters, alcohols, amines, amides, alkyl phenolics, complex organo-phosphoric acids, and their alkali metal and ammonium salts.

Suitable chain transfer agents for the emulsion polymerization process include, for example, mercaptans, polymercaptans, and polyhalogen compounds.

Suitable coagulants for the emulsion polymerization process include, for example, magnesium sulfate, sodium chloride and calcium chloride.

All of the compositions herein may optionally include a catalyst to promote the reaction between GMA and the thermoplastic polyamide or polyester. Such grafting catalysts are well known in the art and include metal salts of hydrocarbon mono- , di- or polycarboxylic acids and metal salts of organic polymers containing carboxyl groups, said cations being selected from the group consisting of Al³⁺, Cd²⁺, Co²⁺, Cu²⁺, Fe²⁺, In³⁺, Mn²⁺, Nd³⁺, Sb³⁺, Sn²⁺, or Zn²⁺. Such catalysts are described in U.S. Pat. No. 4,912,167 assigned to E. I. du Pont de Nemours and Company, herein incorporated as reference.

All of the compositions herein may additionally comprise other materials commonly found in thermoplastic compositions, such as lubricants, fillers, reinforcing agents, dyes, pigments, antioxidants, flame retardants, and antiozonants. The filler material may include glass fibers, carbon fibers, metal fibers, glass beads, asbestos, wollastonite, calcium carbonate, talc, and barium sulfate. These may be used alone or in combination.

The compositions of the invention can also optionally include one or more impact modifiers. The optional impact modifier used in the present invention includes natural or synthetic polymeric materials that are elastic at room temperature. Illustrative of such are natural rubber, butadiene polymer, butadiene-styrene copolymer including random copolymer, block copolymer, graft copolymer and any other structures, isoprene polymer, chlorobutadiene polymer, butadiene-acrylonitrile copolymer, isobutylene polymer, isobutylene-butadiene copolymer, isobutylene-isoprene copolymer, acrylic ester polymer, ethylenepropylene copolymer, ethylenepropylene diene copolymer, Thiokol rubber, polysulfide rubber, polyurethane rubber, polyether rubber such as polypropylene oxide, and epichlorohydrin rubber.

These impact modifiers can be prepared by any known methods, such as emulsion polymerization or solution polymerization, using any known catalysts such as peroxides, trialkyl aluminum, lithium halide or nickel catalysts. The rubber materials can have various degrees of crosslinking and various ratios between micro-structures and cis, trans, and vinyl forms. The impact modifiers can be of any generally available particle size. Further, the copolymer may be random copolymer, block copolymers or graft copolymers. The rubber materials can also include copolymers with other monomers such as olefins, dienes, aromatic vinyl compounds, acrylic acid, acrylic esters, and methacrylic ester. These comonomers may be copolymerized in any manner of random copolymerization, block copolymerization or graft copolymerization. Illustrative of these monomers are, for instance, ethylene, propylene, styrene, CO, chlorostyrene, alpha-methyl styrene, butadiene, isoprene, chlorobutadiene, butene, isobutylene, acrylic acid, methyl acrylate, ethyl acrylate, and acrylonitrile.

Commercially available impact modifiers used in the present invention include Fusabond® EPDM rubbers, Surlyn® ethylene copolymers, Kraton® rubbers, Elvaloy® ethylene copolymers, Paraloid® core/shell rubbers, and the like. These materials may be present in conventional amounts, which vary according to the type(s) of material(s) being added and their purpose in being added. Accordingly it is within the scope of the present invention to provide copolymer compositions comprising impact modifers selected from at least one random copolymer, the random copolymer being selected from the group consisting of branched and straight chain polymers, the polymers being derived from the group consisting of:

(a) ethylene;

(b) CO;

(c) unsaturated monomers selected from the class consisting of alpha, beta-ethylenically unsaturated carboxylic acids having from 3 to 8 carbon atoms, and derivatives thereof selected from the class consisting of monoesters of alcohols of 1 to 29 carbon atoms and the dicarboxylic acids and anhydrides of the dicarboxylic acids and the metal salts of the monocarboxylic, dicarboxylic acids and the monoester of the dicarboxylic acid having from 0 to 100 percent of the carboxylic acid groups ionized by neutralization with metal ions;

(d) unsaturated epoxides of 4 to 11 carbon atoms;

(e) residues derived by the loss of nitrogen from an aromatic sulfonyl azide substituted by carboxylic acids taken from the class consisting of monocarboxylic and dicarboxylic acids having from 7 to 12 carbon atoms and derivatives thereof taken from the class consisting of monoesters of alcohols of 1 to 29 carbon atoms and the dicarboxylic acids and anhydrides of the dicarboxylic acids and the metal salts of the monocarboxylic, dicarboxylic acids and the monoester of the dicarboxylic acid having from 0 to 100 percent of the carboxylic acid groups ionized by neutralization with metal ions;

(f) unsaturated monomers selected from the class consisting of acrylate esters having from 4 to 22 carbon atoms, vinyl esters of acids having from 1 to 20 carbon atoms, vinyl ethers of 3 to 20 carbon atoms, vinyl and vinylidene halides, and nitriles having from 3 to 6 carbon atoms;

(g) unsaturated monomers having at least one substituent selected from the group consisting of pendant hydrocarbon chains of 1 to 12 carbon atoms and pendant aromatic groups optionally having 1 to 6 substituent groups having a total of 14 carbon atoms; and

(h) unsaturated monomers selected from the class consisting of branched, straight chain and cyclic compounds having from 4 to 14 carbon atoms and at least one additional unsaturated carbon-carbon bond capable of being grafted with a monomer having at least one reactive group of the type defined in (c), (d) or (e).

### EXAMPLES

In the Examples below, the following abbreviations are used:

GPC—gel permeation chromatography

PD—polydispersity index

MeMBL—γ-methyl-α-methylenebutyrolactone

MMA—methyl methacrylate

Mn—number average molecular weight

Mw—weight average molecular weight

PD—polydispersity index

T_{g}—glass transition temperature (20° C./min. heating rate)

T_{d}—onset of decomposition temperature (20° C./min. heating rate)

DOS—sodium dioctylsulfosuccinate surfactant

K₂S₂O₈—potassium persulfate initiator

EHT—2-ethylhexylthioglycolate chain transfer agent

GMA—glycidyl methacrylate

MAAM—methacrylamide

EBAGMA—Ethylene-n-butyl acrylate-glycidyl methacrylate copolymer

General Procedure:

Step 1: Polymer Synthesis

The following ingredients were mixed in specified amounts, in a 2 L flask at room temperature using a magnetic stir bar for agitation:

| Material | Weight (g) |
|---|---|
| MeMBL | 322 |
| Dioctylsulfosuccinate | 3.5 |
| glycidyl methacrylate | 28 |
| ethylhexyl thioglycolate | 10.5 |
| water to emulsify | 350 |
| monomers | |

In the next step, 1.7 L water was charged to a 5 L Morton flask equipped with a condenser, mechanical stirrer and a nitrogen sparger. The water was heated to about 80° C. and was sparged with nitrogen as it heated to the specified temperature. Once the water in the flask had reached about 80° C., it was held at that temperature for about 10 min. Subsequently, 10% content by weight of the pre-emulsified mixture of monomer MeMBL, prepared previously, was added to the flask. Potassium persulfate (0.7 g dissolved in 50 mL water) was added to the reaction mixture, all at once. The remainder of the pre-emulsified mixture of monomer MeMBL, prepared previously, was added to the reaction mixture in the Morton flask, over a span of 30 min., accompanied by stirring of the reaction mixture The reaction mixture was stirred for two hours and held at the same temperature of about 80° C. A polymeric emulsion was formed as a result.

Step 2: Coagulation

The polymer emulsion from the reaction mixture in step 1 was cooled to 30° C. 20 g of MgSO₄ dissolved in 200 mL water were then added to the polymeric emulsion by means of an addition funnel over a span of 5 min. This caused coagulation of the emulsion to give fine particles of MeMBL-GMA copolymer. Subsequently, ethyl acetate was added at room temperature to the emulsion by means of an addition funnel until the polymer became granular or formed bead shaped agglomerates. The amount of ethyl acetate to be added varies with the content of glycidyl methacrylate added in experiment 1, however the general range of addition was of about 500 mL. The contents in the flask were stirred for about 10 to 15 min.

In the next step, the coagulate, inclusive of the polymer granules, was filtered at room temperature. The coagulate was subsequently washed with water and allowed to air dry on a fritted glass funnel for 24 hours. A constant sweep of nitrogen and house vacuum was adequate to remove the majority of the moisture. Following the vacuum drying step, the polymeric material was oven dried at about 70° C. for 24 hours to remove residual moisture. The moisture content of the polymer was typically less than about 1%.

Step 3: Polymer Blending

Standard procedures were used for blending. In a typical procedure, the thermoplastic polymer pellets are mixed with the alpha-ML polymer in a polyethylene bag. The contents of the bag are placed in the hopper of the extruder and fed in to the extruder barrel via screw feeders. If the extruder is equipped with multiple feed positions, the thermoplastic polymer may be fed simultaneously with the alpha-ML polymer.

Polyamide-6 as Zytel®7301 grade or Capron® 8200 (Allied Signal), Polyamide-6,6 as Zytel®101 grade, and filled Polyamide-6 as Minlon® FE6228 grade, PBT as Crastin® 6129, PET as Crystar® 3924 or Crystar® 3934, ethylene/methyl acrylate/n-butyl acrylate/zinc ionomer for toughening polyamides as various grades of Surlyn®, and an ethylene/propylene polymer containing maleic anhydride grafts as Fusabond®MN493D were obtained from E. I. du Pont de Nemours and Co., Wilmington, Del.

The copolymers of the comparative examples or the MeMBL/GMA copolymer, polyamide, and optionally, the impact modifiers Surlyn® and/or Fusabond MN493D were blended and subsequently compounded in either a 16 mm twin screw Prism® extruder or a 30 mm twin screw Werner Pfielder® twin screw extruder. For examples in which polyamide-6,6 or Crystar® PET was used, the feed zone of the extruder was maintained at about 240° C., the barrel temperatures were maintained at about 280° C. For examples in which polyamide-6 or Crastin® PBT was used, the feed zone of the extruder was maintained at about 200° C., the barrel temperatures were maintained at about 270° C.

### Examples 1-7

Examples 1-7 are comparative examples wherein 45% by weight of nylon-6,6 or Zytel® 101 was blended with 45% by weight of MeMBL/MAAM copolymer wherein the copolymer contained 10% methacrylamide as a compatibilizer. 10% by weight of different impact modifiers or their mixtures were also used for the blend preparation.

| | Example | | | | | | |
|---|---|---|---|---|---|---|---|
| | 1 | 2 | 3 | 4 | 5 | 6 | 7 |
| Ingredients (parts) | | | | | | | |
| Zytel(R) | 45 | 45 | 45 | 45 | 45 | 45 | 45 |
| 101Nylon66 | | | | | | | |
| 10% MAAM/MeMBL | 45 | 45 | 45 | 45 | 45 | 45 | 45 |
| copolymer | | | | | | | |
| Impact modifier 1 | Surlyn9320 | Surlyn9520 | Surlyn9020 | SurlynAD1002 | FusabondMF416D | Ebagma | Ebagma |
| (grade) | | | | | | | 5% GMA |
| Impact modifier 1 | 10 | 10 | 10 | 10 | 10 | 10 | 5 |
| (parts) | | | | | | | |
| Impact modifier 2 | | | | | | | Surlyn9320 |
| (grade) | | | | | | | |
| Impact modifier 2 | | | | | | | 5 |
| (parts) | | | | | | | |
| total parts | 100 | 100 | 100 | 100 | 100 | 100 | 100 |
| Properties (DAM) | | | | | | | |
| HDT@1.8 MPa (° C.) | 127 | 129 | 144 | 147 | 145 | 151 | 149 |
| Elongation at Break | 2 | 1 | 2 | 2 | 2 | 2 | 2 |
| (%) 5 mm/min | | | | | | | |
| Tensile Strength at | 47.1 | 41.7 | 42.6 | 47.7 | 44.9 | 41.6 | 44.2 |
| Break (MPa) | | | | | | | |
| Flex Modulus (MPa) | 2997 | 3163 | 3094 | 3059 | 2880 | 3059 | 3025 |
| Notched Izod (J/m) | 51 | 14 | 14 | 15 | 20 | 18 | 18 |

### Examples 8-14

In Examples 8-14 are comparative examples wherein 45% by weight of nylon-6,6 or Zytel® 101 was blended with 45% by weight of MeMBL/Itaconic Anhydride copolymer wherein the copolymer contained 10% Itaconic Anhydride as a compatibilizer. 10% by weight of different impact modifiers or their mixtures were also used for the blend preparation.

| | Example | | | | | | |
|---|---|---|---|---|---|---|---|
| | 8 | 9 | 10 | 11 | 12 | 13 | 14 |
| Ingredients (parts) | | | | | | | |
| Zytel(R) | 45 | 45 | 45 | 45 | 45 | 45 | 45 |
| 101Nylon66 | | | | | | | |
| 1% IAnH/MeMBL | 45 | 45 | 45 | 45 | 45 | 45 | 45 |
| copolymer | | | | | | | |
| Impact modifier 1 | Surlyn9320 | Surlyn9520 | Surlyn9020 | SurlynAD1002 | FusabondMF416D | Ebagma | Ebagma |
| (grade) | | | | | | | 5% GMA |
| Impact modifier 1 | 10 | 10 | 10 | 10 | 10 | 10 | 5 |
| (parts) | | | | | | | |
| Impact modifier 2 | | | | | | | Surlyn9320 |
| (grade) | | | | | | | |
| Impact modifier 2 | | | | | | | 5 |
| (parts) | | | | | | | |
| total parts | 100 | 100 | 100 | 100 | 100 | 100 | 100 |
| Properties (DAM) | | | | | | | |
| HDT@1.8 MPa (° C.) | 124 | 131 | 131 | 153 | 145 | 156 | |
| Elongation at Break | 2 | 2 | 2 | 2 | 2 | 2 | 2 |
| (%) 5 mm/min | | | | | | | |
| Tensile Strength at | 47.4 | 49.8 | 47.2 | 47.4 | 43.4 | 42.3 | 40.7 |
| Break (MPa) | | | | | | | |
| Flex Modulus (MPa) | 2956 | 3149 | 2997 | 3011 | 2852 | 3066 | 2928 |
| Notched Izod (J/m) | 26 | 20 | 23 | 12 | 14 | 18 | 14 |

### Examples 15-21

Examples 15-21 are comparative examples wherein nylon-6 or Capron® 8200 ranging from 50% to 80% by weight was blended with MeMBL/acetoacetoxyethyl methacrylate copolymer ranging from 10% to 40% by weight wherein the copolymer contained 5% AAEM as a compatibilizer. 10% by weight of different impact modifiers or their mixtures were also used for the blend preparation.

| | Example | | | | | | |
|---|---|---|---|---|---|---|---|
| | 15 | 16 | 17 | 18 | 19 | 20 | 21 |
| Ingredients (parts) | | | | | | | |
| Capron8200 Nylon6 | 80 | 70 | 60 | 50 | 40 | 60 | 50 |
| Surlyn9320 | 10 | 10 | 10 | 10 | 10 | | |
| Surlyn9020 | | | | | | 10 | 10 |
| 5% AAEM/MeMBL | 10 | 20 | 30 | 40 | 45 | 30 | 40 |
| copolymer | | | | | | | |
| total parts | 100 | 100 | 100 | 100 | 95 | 100 | 100 |
| Properties (DAM) | | | | | | | |
| HDT@1.8 MPa (° C.) | 57 | 57 | 71 | 142 | 150 | 63 | 136 |
| Elongation at Break (%) 5 mm/min | 5.2 | 2 | 2 | 1 | 1 | 1.8 | 1.1 |
| Tensile Strength at Break (MPa) | 61 | 54 | 45 | 38 | 42 | 44 | 30 |
| Flex Modulus (MPa) | 2501 | 2570 | 2763 | 2976 | 3225 | 2728 | 2963 |
| Notched Izod (J/m) | 62 | 39 | 47 | 18 | 17 | 23 | 13 |

### Examples 22-33

In Examples 22-30, 64% by weight of Nylon-6 or Zytel® 7301, was blended with 21% by weight MeMBL/GMA copolymer wherein the copolymer contained GMA ranging from 4% to 13% by weight as a compatibilizer. 15% by weight of different impact modifiers or their mixtures were used for the blend preparation in these Examples.

In Examples 31-33, 50% by weight of Nylon-6 or Zytel® 7301 was blended with 40% by weight of MeMBL/GMA copolymer wherein the copolymer contained GMA ranging from 4% to 13% as a compatibilizer. 10% by weight of different impact modifiers or their mixtures were used for the blend preparation.

| | Examples | | | | | | | | | | | |
|---|---|---|---|---|---|---|---|---|---|---|---|---|
| | 22 | 23 | 24 | 25 | 26 | 27 | 28 | 29 | 30 | 31 | 32 | 33 |
| Step 1 (parts) | | | | | | | | | | | | |
| Zytel(R) | 21 | 21 | 21 | 21 | 21 | 21 | 21 | 21 | 21 | 40 | 40 | 40 |
| 7301Nylon6 | | | | | | | | | | | | |
| MeMBL copolymer | 21 | 21 | 21 | 21 | 21 | 21 | 21 | 21 | 21 | 40 | 40 | 40 |
| GMA in copolymer | 4 | 8 | 13 | 4 | 8 | 13 | 4 | 8 | 13 | 4 | 8 | 13 |
| (%) | | | | | | | | | | | | |
| Mw (×10−3)of | 66 | 59 | 100 | 34 | 41 | 37 | 32 | 39 | 53 | 31 | 31 | 45 |
| GMA copolymer | | | | | | | | | | | | |
| Step 2 (parts) | | | | | | | | | | | | |
| Zytel(R) | 43 | 43 | 43 | 43 | 43 | 43 | 43 | 43 | 43 | 10 | 10 | 10 |
| 7301Nylon6 | | | | | | | | | | | | |
| Step 3 (parts) | | | | | | | | | | | | |
| Fusabond(R)MN4 | 15 | 15 | 15 | 15 | 15 | 15 | | | | 10 | 10 | 10 |
| 93D | | | | | | | | | | | | |
| Surlyn(R)9320 | | | | | | | 15 | 15 | 15 | | | |
| total parts | 100 | 100 | 100 | 100 | 100 | 100 | 100 | 100 | 100 | 100 | 100 | 100 |
| Properties (DAM) | | | | | | | | | | | | |
| HDT@0.45 MPa | | 152 | | | 160 | | | 159 | | 168 | 147 | 143 |
| (° C.) | | | | | | | | | | | | |
| HDT@1.8 MPa | 49 | 51 | 51 | 51 | 49 | 51 | 54 | 53 | 53 | 106 | 69 | 64 |
| (° C.) | | | | | | | | | | | | |
| Elongation at | 17 | 78 | 35 | 38 | 75 | 41 | 24 | 36 | 34 | 3 | 7 | 11 |
| Break (%) | | | | | | | | | | | | |
| 5 mm/min | | | | | | | | | | | | |
| Tensile Strength at | 40.0 | 44.4 | 45.9 | 42.4 | 44.1 | 47.9 | 42.9 | 47.3 | 50.9 | 42.8 | 42.3 | 45.2 |
| Break (MPa) | | | | | | | | | | | | |
| Flex Modulus | 1605 | 1743 | 1791.4 | 1771 | 1757 | 1812 | 1957 | 1874 | 1991 | 2205 | 2088 | 2163 |
| (MPa) | | | | | | | | | | | | |
| Notched Izod (J/m) | 55 | 151 | 146 | 89 | 129 | 171 | 37 | 57 | 86 | 23 | 44 | 64 |
| Mold shrinkage | | 1.78 | 1.75 | | 1.67 | | | | | 1.22 | | |
| (linear, %) | | | | | | | | | | | | |

### Examples 34-39

In Examples 34-39, 60% by weight of Nylon-6,6 or Zytel® 101 was blended with 25% by weight MeMBL/GMA copolymer wherein the copolymer contained GMA ranging from 2% to 6% by weight as a compatibilizer. 15% by weight of different impact modifiers or their mixtures were used for the blend preparation.

| | Example | | | | | |
|---|---|---|---|---|---|---|
| | 34 | 35 | 36 | 37 | 38 | 39 |
| Step 1 (parts) | | | | | | |
| Zytel(R) 101 | 25 | 25 | 25 | 25 | 25 | 25 |
| MeMBL copolymer | 25 | 25 | 25 | 25 | 25 | 25 |
| GMA in copolymer (%) | 2 | 4 | 6 | 2 | 4 | 6 |
| Mw (×10−3)of GMA | 31.9 | 33.6 | 36.2 | 31.9 | 33.6 | 36.2 |
| copolymer | | | | | | |
| Step 2 (parts) | | | | | | |
| Zytel(R) 101 | 35 | 35 | 35 | 35 | 35 | 35 |
| Fusabond(R)MF416D | 15 | 15 | 15 | | | |
| Surlyn(R)9320 | | | | 15 | 15 | 15 |
| total parts | 100 | 100 | 100 | 100 | 100 | 100 |
| Properties (DAM) | | | | | | |
| HDT@1.8 MPa (° C.) | 82 | 70 | 75 | 103 | 89 | 62 |
| Elongation at Break (%) 5 mm/min | 2.7 | 5 | 2.7 | 2.8 | 3.5 | 9.5 |
| Tensile Strength at Break (Mpa) | 48 | 48 | 49 | 48 | 52 | 47 |
| Flex Modulus (Mpa) | 2274 | 2281 | 2197.9 | 2439 | 2343 | 2212 |
| Notched Izod (J/m) | 31 | 41 | 57 | 40 | 46 | 66 |

### Examples 40-59

In Examples 40-59, a Design of Experiments was performed varying weights of Nylon-6 or Zytel® 7301 was blended with varying weights of MeMBL/GMA copolymer wherein the copolymer contained GMA at 8% by weight as a compatibilizer. Minion® FE 6228 was also added to some blends. These blending processes were carried out in three steps. Fusabond® MN493D was also added to some samples in the third step of the process.

| | Example | | | | | | | | | |
|---|---|---|---|---|---|---|---|---|---|---|
| | 40 | 41 | 42 | 43 | 44 | 45 | 46 | 47 | 48 | 49 |
| Step 1 (parts) | | | | | | | | | | |
| Zytel(R) 7301Nylon6 | 25 | 30 | 30 | 20 | 25 | 20 | 30 | 25 | 25 | 25 |
| 8% GMA/MeMBL | 25 | 30 | 30 | 20 | 25 | 20 | 30 | 25 | 25 | 25 |
| copolymer | | | | | | | | | | |
| Minlon* FE6228 | 5 | 0 | 0 | 10 | 5 | 0 | 5 | 0 | 5 | 5 |
| Step 2 (parts) | | | | | | | | | | |
| Zytel(R) 7301Nylon6 | 30 | 30 | 20 | 40 | 30 | 50 | 20 | 35 | 30 | 30 |
| Step 3 (parts) | | | | | | | | | | |
| Fusabond(R)MN493D | 15 | 10 | 20 | 10 | 15 | 10 | 15 | 15 | 15 | 15 |
| total parts | 100 | 100 | 100 | 100 | 100 | 100 | 100 | 100 | 100 | 100 |
| Properties (DAM) | | | | | | | | | | |
| HDT@1.8 Mpa (° C.) | 59.1 | 56 | 52.4 | 66.5 | 56.3 | 55 | 64.1 | 55.2 | 62.1 | 64.3 |
| HDT@0.45 MPa (° C.) | 165.4 | 161.7 | 151 | 170.9 | 168.2 | 174 | 165.8 | 170.4 | 167 | 169.6 |
| Elongation at Break (%) | 12 | 7 | 13 | 13 | 14 | 10 | 6 | 9 | 12 | 12 |
| 5 mm/min | | | | | | | | | | |
| Tensile Strength at | 47 | 48 | 36 | 59 | 47 | 58 | 47 | 49 | 50 | 51 |
| Break (Mpa) | | | | | | | | | | |
| Flex Modulus (Mpa) | 2046 | 2115 | 1709 | 2425 | 2019 | 2308 | 2163 | 2081 | 2143 | 2157 |
| Notched Izod (J/m) | 80 | 64 | 92 | 47 | 75 | 55 | 31 | 86 | 68 | 68 |
| | Example | | | | | | | | | |
| | 50 | 51 | 52 | 53 | 54 | 55 | 56 | 57 | 58 | 59 |
| Step 1 (parts) | | | | | | | | | | |
| Zytel(R) 7301Nylon6 | 25 | 30 | 25 | 20 | 25 | 20 | 20 | 30 | 25 | 25 |
| 8% GMA/MeMBL | 25 | 30 | 25 | 20 | 25 | 20 | 20 | 30 | 25 | 25 |
| copolymer | | | | | | | | | | |
| Minlon* FE6228 | 5 | 10 | 10 | 0 | 5 | 5 | 10 | 10 | 5 | 5 |
| Step 2 (parts) | | | | | | | | | | |
| Zytel(R) 7301Nylon6 | 25 | 20 | 25 | 40 | 30 | 40 | 30 | 10 | 35 | 30 |
| Step 3 (parts) | | | | | | | | | | |
| Fusabond(R)MN493D | 20 | 10 | 15 | 20 | 15 | 15 | 20 | 20 | 10 | 15 |
| total parts | 100 | 100 | 100 | 100 | 100 | 100 | 100 | 100 | 100 | 100 |
| Properties (DAM) | | | | | | | | | | |
| HDT@1.8 Mpa (° C.) | 56.5 | 69.2 | 59.2 | 51.4 | 57.7 | 59.6 | 54.8 | 56.1 | 62.2 | 60.5 |
| HDT@0.45 MPa (° C.) | 151.4 | 169 | 157 | 154 | 161 | 165 | 156 | 148 | 173 | 166 |
| Elongation at Break (%) | 21 | 4.2 | 11.2 | 15.3 | 8.7 | 23.6 | 25.5 | 15.1 | 10 | 11.2 |
| 5 mm/min | | | | | | | | | | |
| Tensile Strength at | 40 | 54 | 45 | 43 | 49 | 50 | 41 | 32 | 57 | 51 |
| Break (Mpa) | | | | | | | | | | |
| Flex Modulus (Mpa) | 1764 | 2494 | 1998 | 1764 | 2129 | 2039 | 1750 | 1509 | 2370 | 2163 |
| Notched Izod (J/m) | 106 | 32 | 80 | 286 | 71 | 151 | 336 | 63 | 32 | 56 |

### Examples 60-65

In Examples 60-65, Crastin® 6129 PBT, was blended with MeMBL/GMA copolymer wherein the copolymer contained GMA ranging from 3% to 7% by weight as a compatibilizer. The effect of an impact modifier is shown in Examples 63 through 65.

| | | Example | | | | | |
|---|---|---|---|---|---|---|---|
| | Crastin(R)6129 | 60 | 61 | 62 | 63 | 64 | 65 |
| Step 1 (parts) | | | | | | | |
| MeMBL copolymer | | 25 | 25 | 25 | 23 | 23 | 23 |
| Crastin(R) 6129 PBT | | 25 | 25 | 25 | 23 | 23 | 23 |
| Step 2 (parts) | | | | | | | |
| Crastin(R) 6129 PBT | | 50 | 50 | 50 | 45 | 45 | 45 |
| Step 3 (parts) | | | | | | | |
| Ebagma 5% GMA | | | | | 10 | 10 | 10 |
| % GMA in MeMBL | | 3 | 5 | 7 | 3 | 5 | 7 |
| copolymer | | | | | | | |
| total parts | | 100 | 100 | 100 | 100 | 100 | 100 |
| Properties (DAM) | | | | | | | |
| HDT@45 MPa (° C.) | 151 | | | 174 | | | 143 |
| HDT@1.8 MPa (° C.) | 46 | | | 78 | | | 46 |
| Elongation at Break | >100 | 2 | 1.9 | 1.9 | 2.3 | 2.4 | 24 |
| (%) 5 mm/min | | | | | | | |
| Tensile Strength at | 55.2 | 47.3 | 45.2 | 43.9 | 38.6 | 38.5 | 33.2 |
| Break (MPa) | | | | | | | |
| Flex Modulus (MPa) | 2398 | 3025 | 2852 | 2859 | 2232 | 2150 | 1729 |
| Notched Izod (J/m) | 50 | 31 | 23 | 21 | 50 | 47 | 101 |

### Examples 66-69

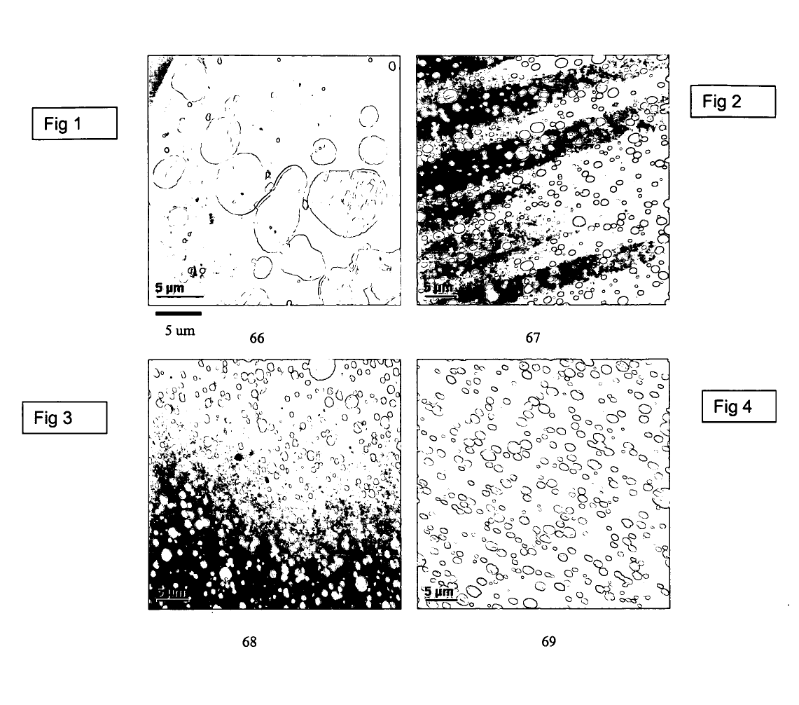

In Examples 66-69 Crystar® 3924 PET (80 parts by weight), was blended with MeMBL/GMA copolymer (20 parts by weight) wherein the copolymer contained GMA ranging from 0% to 3% by weight as a compatibilizer. FIGS. 1-4 illustrate the transmission electron micrographs (TEM) of injection molded bars show the effect of GMA in the blend. TEM was performed by sectioning molded plaques or pieces by cryo-ultramicrotomy. Sections of a nominal thickness of 90 nm were accumulated in cold ethanol, transferred to water and retrieved on copper mesh grids. For blends containing polyethyleneterephthalate (PET) or PBT, the grids were exposed to RuO₄ vapor for 2 hours. Samples with nylon were stained overnight by floating the sections on 1% aqueous phosphotungstic acid. Images were obtained using a JEOL 1200 EX TEM operated at 100 KV accelerating voltage and recorded on sheet film.

Example

| | 66 | 67 | 68 | 69 |
|---|---|---|---|---|
| Crystar ® 3924 | 80 | 80 | 80 | 80 |
| PET | | | | |
| GMA/MeMBL | 20 | 20 | 20 | 20 |
| copolymer | | | | |
| Wt % GMA in | 0 | 1 | 2 | 3 |
| MeMBL copolymer | | | | |

What is claimed is:

1. A copolymer composition comprising:
(a) at least one polymeric repeat unit represented by formula I derived from alpha-methylene lactone monomer,
(b) at least one polymeric repeat unit represented by formula II derived from glycidyl methacrylate monomer, and
(c) optionally, at least one polymeric repeat unit represented by formula III derived from a monoethyleneically unsaturated monomer, 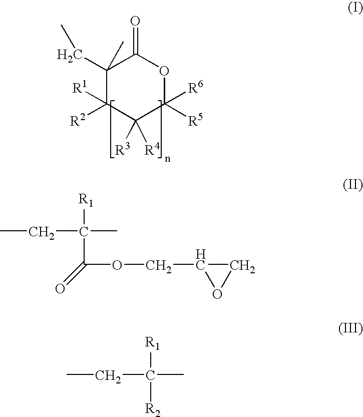
wherein: n is 0, 1 or 2;
R¹, R², R³, R⁴, R⁵, R⁶, are independently hydrogen, a functional group, hydrocarbyl or substituted hydrocarbyl.

2. A copolymer composition comprising:
(a) at least one polymeric repeat unit represented by formula I derived from alpha-methylene lactone monomer,
(b) at least one polymeric repeat unit represented by formula II derived from glycidyl methacrylate monomer, wherein said polymeric repeat unit represented by formula II comprises from about 0.5% to about 45% by weight of the copolymer composition;
(c) at least one thermoplastic material selected from polyamide or polyester,
(d) optionally, from 1% to 50% of at least one a polymeric repeat unit represented by formula III derived from a monoethyleneically unsaturated monomer, and
(e) optionally, one or more impact modifier in the range from 0.5% to 35% by total weight of the composition, 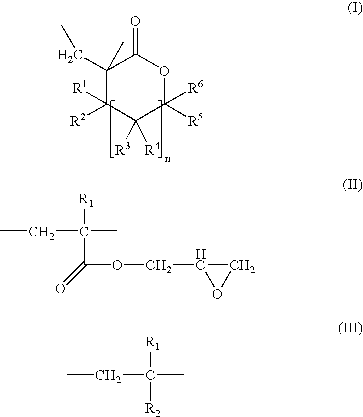
wherein: n is 0, 1 or 2;
R¹, R², R³, R⁴, R⁵, R⁶, are independently hydrogen, a functional group, hydrocarbyl or substituted hydrocarbyl.

3. The composition of claim 1 or claim 2 wherein when n=0; R¹, R², and R⁵ are independently hydrogen, and R⁶ is methyl.

4. The composition of claim 1 or claim 2 wherein the content of the polymeric repeat unit represented by formula II derived from glycidyl methacrylate monomer is from about 0.5% to about 35% of the total composition.

5. The composition of claim 2 wherein the polyamide is selected from polyamide-4, polyamide-6, polyamide-6,6, polyamide-3,4, polyamide-11, polyamide-12, polyamide-6,10, polyamide-6,12, polyamides prepared from terephthalic acid and 4,4′-diaminocyclohexyl methane, polyamides prepared from azelaic acid, adipic acid and 2,2 bis-(p-aminocyclohexyl)propane, polyamides prepared from adipic acid and metaxylylene diamine, polyamides from terephthalic acid and trimethyl hexamethylene diamine, and combinations thereof.

6. The composition of claim 2 wherein the impact modifier is selected from at least one random copolymer, the random copolymer being selected from the group consisting of branched and straight chain polymers, the polymers being derived from the group consisting of:
(a) ethylene;
(b) CO;
(c) unsaturated monomers selected from the class consisting of alpha, beta-ethylenically unsaturated carboxylic acids having from 3 to 8 carbon atoms, and derivatives thereof selected from the class consisting of monoesters of alcohols of 1 to 29 carbon atoms and the dicarboxylic acids and anhydrides of the dicarboxylic acids and the metal salts of the monocarboxylic, dicarboxylic acids and the monoester of the dicarboxylic acid having from 0 to 100 percent of the carboxylic acid groups ionized by neutralization with metal ions;
(d) unsaturated epoxides of 4 to 11 carbon atoms;
(e) residues derived by the loss of nitrogen from an aromatic sulfonyl azide substituted by carboxylic acids taken from the class consisting of monocarboxylic and dicarboxylic acids having from 7 to 12 carbon atoms and derivatives thereof taken from the class consisting of monoesters of alcohols of 1 to 29 carbon atoms and the dicarboxylic acids and anhydrides of the dicarboxylic acids and the metal salts of the monocarboxylic, dicarboxylic acids and the monoester of the dicarboxylic acid having from 0 to 100 percent of the carboxylic acid groups ionized by neutralization with metal ions;
(f) unsaturated monomers selected from the class consisting of acrylate esters having from 4 to 22 carbon atoms, vinyl esters of acids having from 1 to 20 carbon atoms, vinyl ethers of 3 to 20 carbon atoms, vinyl and vinylidene halides, and nitrites having from 3 to 6 carbon atoms;
(g) unsaturated monomers having at least one substituent selected from the group consisting of pendant hydrocarbon chains of 1 to 12 carbon atoms and pendant aromatic groups optionally having 1 to 6 substituent groups having a total of 14 carbon atoms; and
(h) unsaturated monomers selected from the class consisting of branched, straight chain and cyclic compounds having from 4 to 14 carbon atoms and at least one additional unsaturated carbon-carbon bond capable of being grafted with a monomer having at least one reactive group of the type defined in (c), (d) or (e).

7. A method for preparing a copolymer composition, the method comprising the steps of:
(a) contacting at least one alpha methylene lactone monomer of formula (I) with a glycidyl methacrylate monomer of general formula (II), in an aqueous medium,
(b) optionally, contacting the product of step (a) with a chain-transfer agent and a surfactant,
(c) contacting the product of step (a) or step (b) with an initiator,
(d) contacting the product of step (c) with a coagulant, to obtain the copolymer composition,
(e) optionally, contacting the product of step (d) with ethyl acetate,
(f) optionally, agitating the product of step (e),
(g) optionally, filtering the copolymer composition, and
(h) optionally, drying the copolymer composition.

8. The method of claim 7 wherein the alpha methylene lactone monomer is 5-methyl-alpha-methylene-gamma-butyrolactone.

9. The method of claim 8 wherein the chain transfer agent is 2-ethylhexylthioglycolate, the surfactant is dioctylsulfosuccinate, the initiator is potassium persulfate, and the coagulant is MgSO₄.

10. The method of claim 7 wherein the chain transfer agent is selected from mercaptans, polymercaptans, and polyhalogen compounds.

11. The method of claim 7 wherein the surfactant is selected from alkali metal and ammonium salts of alkyl, aryl, alkaryl, and ara-alkyl sulfonates, sulfates, and polyether sulfates, ethoxylated fatty acids, esters, alcohols, amines, amides, alkyl phenols, complex organo-phosphoric acids, and their alkali metal and ammonium salts

12. The method of claim 7 wherein the initiator is selected from the group consisting of thermal initiators, azo-type initiators, persulfates, peroxysulfates, and redox-type initiators, wherein the thermal initiators are selected from the group consisting of organo peroxides, acetyl peroxides, lauroyl peroxide, t-butyl peroxide, di-t-butyl hydroperoxide, and peresters; and the redox-type initiators are selected from the group consisting of hydroperoxide being selected from the group consisting of hydrogen peroxide, t-butyl hydroperoxide, cumene hydroperoxide, and diisopropyl-benzene hydroperoxide, and a reducing agent being selected from the group consisting of sodium, potassium, or ammonium bisulfite, metabisulfite, hydrosulfite, sulfur dioxide, hydrazine, ferrous salts, isoascorbic acid, and sodium formaldehyde sulfoxalate.

13. The method of claim 7 wherein the coagulant is selected from magnesium sulfate, sodium chloride, calcium chloride.

14. A shaped, molded or extruded article comprising the copolymer composition of claim 1 or claim 2.
